(19) United States
(12) Patent Application Publication
(10) Pub. No.: US 2008/0129070 A1
(43) Pub. Date: Jun. 5, 2008

(54) Sealing nozzle and method for producing vehicle body by using the same

(75) Inventors: Yuichi Noda, Tokyo (JP); Hideki Murakami, Tokyo (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/999,244

(22) Filed: Dec. 4, 2007

(30) Foreign Application Priority Data
Dec. 5, 2006 (JP) 2006-328626

(51) Int. Cl. B05B 1/34; B62D 39/00

(52) U.S. Cl. 296/29; 222/566

(57) ABSTRACT

A sealing nozzle having a flattened tubular part for discharging a sealer is disclosed. A restrictive means is provided so as to stretch out from one side to the other inside a sealer passage of the flattened tubular part and to restrict the flow of the sealer.

### FILED OF THE INVENTION

The present invention relates to a sealing nozzle and a method for producing a vehicle body by use of the nozzle.

### BACKGROUND OF THE INVENTION

Shown in FIG. 12 hereof is an ordinary vehicle door 100 which has an outer plate 101 on the vehicle outside and an inner plate 102 disposed alongside the outer plate 101.

FIG. 13 is a cross-sectional view taken along line 13-13 of FIG. 12. In FIG. 13, the outer plate 101 and the inner plate 102 are integrally joined by bending the rim part of the outer plate 101 back over the rim part of the inner plate 102. Such a process is known as “hemming.”

In such hemming, minute crevices will inevitably exist, raising concern over rainwater infiltration and the entry of wind. As a countermeasure to these dangers, a sealer 103 is applied as illustrated. The sealer 103 is a filling material that prevents crevices from forming, is a viscous material at the time of filling (application), and solidifies and becomes a solid material when a set amount of time passes after application. Therefore, the sealer can block out rainwater and wind. The sealer 103 is applied with a sealing nozzle.

The aforementioned sealing nozzle is disclosed in Japanese Utility Model Application Laid-Open Publication No. 6-77842. This sealing nozzle is described below based on FIG. 14.

The conventional sealing nozzle 110 shown in FIG. 14 is comprised of a pipe 111 for transporting the sealant, a bent part 112 disposed in the middle portion of the pipe 11 1, and a flattened tube part 114 disposed at the distal end of the pipe 111 and used to discharge the sealer from an oblong opening 113 in the distal end.

Because the oblong opening 113 of the flattened tube part 114 can discharge the sealer in the form of a film, the sealer can be applied in a spread configuration.

Next, a specific example of applying a sealer to a vehicle door by a sealing nozzle having a structure similar to that of the sealing nozzle 110 is described with reference to FIGS. 15A and 15B.

The sealing nozzle 120 shown in FIG. 15A, apart from the bent part 112 (FIG. 14), has substantially the same structure as the sealing nozzle 110, and is further provided with a guide member 121 that stretches out from the pipe 111 and is used to guide the flattened tube part 114 by following the door 100 as a coating workpiece.

In FIG. 15A, the distal end of the sealing nozzle 120 is brought against the application part (boundary 124 between a folded part 122 of an outer plate and an inner plate 123).

In FIG. 15B, the sealing nozzle 120 is moved slowly while the sealer 125 is discharged from the sealing nozzle 120. In this case, the boundary 124 is coated with the sealer 125. The shape of the sealer 125 is shown in detail in FIG. 16.

As shown in FIG. 16, an application start area A and a subsequent application continuation area B have different shapes. The application width Wb of the application continuation area B corresponds to the width of the distal end of the sealing nozzle 120 (FIG. 15B). In contrast, the application width Wa of the application start area A is markedly greater than Wb and creates an overcoating that protrudes outward to the left of the folded part 122 of the outer plate in the left-hand side of the drawing. This overcoated portion 126 must be wiped off with waste cloth or aftertreated in another manner. As a result, problems arise in that the operating time increases and the sealing operation becomes more complicated.

The reason that the application start area A widens considerably is that the sealing nozzle 120 is stopped at the start of application. A need exists for removing the overcoated portion 126 and rendering clean-up work unnecessary.

### SUMMARY OF THE INVENTION

It is an object of the present invention to provide a sealing nozzle wherein clean-up work in the application start area is rendered unnecessary.

According to a first aspect of the present invention, there is provided a sealing nozzle which comprises: a pipe for transporting a sealer; a flattened tubular part disposed at a distal end of the pipe for discharging the sealer from an oblong opening at a distal end of the flattened tubular part; a guide member that stretches out from one of the pipe and the flattened tubular part for guiding the flattened tubular part to an application part of a coating workpiece by following the coating workpiece; and restrictive means designed to make the flow of the sealer in the flattened tubular part in proximity to the guide member slower than the flow in an area distant from the guide member.

In the nozzle of the present invention, the flow of the sealer in the flattened tubular part in proximity to the guide member is slowed down in comparison with the flow of the sealer in an area distant from the guide member by the restrictive means for varying the flow of the sealer, eliminating the concern that the sealer will protrude toward the guide member. When the sealer protrudes toward the guide member, the overcoated contaminated portion must be wiped off. The present invention, however, can eliminate the overcoated portion and dispense with wiping and other aftertreatments, as described above.

Preferably, the restrictive means comprises a resistance member that projects out from the internal peripheral surface toward the interior of the flattened tubular part, or a depression that is sunk in so as to protrude from the exterior to the interior of the flattened tubular part. Therefore, the flow of the sealer can be locally restricted by the resistance member or the depression. The resistance member or the depression is simple to produce and can be easily provided to the interior of the flattened tubular part.

In a preferred form, the shape of the resistance member or the shape of the depression is substantially rectangular. Resistance can be increased if a long side of the rectangle is oriented along the flow. In addition, the simple shape makes it easier to process and manufacture the sealing nozzle.

Desirably, the restrictive means is designed such that a center line of the flattened tubular part is displaced toward the guide member and away from a center line of the pipe. Therefore, the sealer flows mostly along the center line of the pipe, and the flow is reduced in areas far from the center line of the pipe. The overcoated portion of sealer can therefore be eliminated, and wiping or other aftertreatments can be omitted.

According to a second aspect of the present invention, there is provided a method for producing a body of an automobile by applying a sealer to a work area of at least two steel sheets that constitute the automobile body, the method comprising the steps of: providing a sealing nozzle having a pipe for transporting the sealer, a flattened tubular part disposed at a distal end of the pipe for discharging the sealer from an oblong opening at a distal end of the flattened tubular part, a guide member that stretches out from the pipe or the flattened tubular part for guiding the flattened tubular part to an application part of a coating workpiece by following the coating workpiece, and restrictive means designed to make the flow of the sealer in the flattened tubular part in proximity to the guide member slower than the flow in an area distant from the guide member; bringing the guide member against one edge part of one of the steel sheets; and applying the sealer to an overlapping area of the two steel sheets while sliding the sealing nozzle along the edge part.

In the arrangement of the second aspect, the sealer can be prevented from protruding to the exterior of the vehicle body when application of the sealer is started. As a result, labor involved in applying the sealer in the manufacturing of a vehicle body can be reduced. In addition, overcoating causes increased water leaks and air cutting noise, as well as formation of rust and crevices. Because such overcoating can be removed in accordance with the present invention, formation of water leaks in the vehicle body can be prevented, the air cutting noise can be reduced, the formation of rust on the vehicle body can be prevented, and the infiltration of dirt into the vehicle body can be prevented as well.

### BRIEF DESCRIPTION OF THE DRAWINGS

Certain preferred embodiments of the present invention will be described in detail below, by way of example only, with reference to the accompanying drawings, in which:

FIGS. 1A and 1B are schematic views showing a sealer applied to an inner panel by using a conventional nozzle;

FIGS. 2A and 2B are schematic views showing an example in which the applied sealer is prevented from protruding beyond the inner panel;

FIGS. 3A through 3C are views showing a plurality of experimental examples of restricting the flow of a sealer;

FIG. 4 is a schematic view showing, partially in section, a sealing nozzle according to a first embodiment of the present invention;

FIG. 5A is a cross-sectional view taken along line 5A-5A of FIG. 4;

FIG. 5B is a cross-sectional view taken along line 5B-5B of FIG. 4;

FIG. 5C is a view as seen from arrow 5C of FIG. 4;

FIG. 6 is schematic view showing an operation of the sealing nozzle shown in FIG. 4;

FIGS. 7A and 7B are views showing the manner in which the sealer flows through the sealing nozzle according to the first embodiment;

FIG. 8 is a view showing a sealing nozzle according to a second embodiment of the present invention;

FIG. 9 is a view showing a sealing nozzle according to a third embodiment of the present invention;

FIG. 10 is a flowchart showing the sealant application step according to the present invention;

FIGS. 11A and 11B are views showing the manner in which the sealer is applied by the sealing nozzle of the present invention;

FIG. 12 is a front view of a vehicle door;

FIG. 13 is a cross-sectional view taken along line 13-13 of FIG. 12;

FIG. 14 is a perspective view showing a conventional sealing nozzle;

FIGS. 15A and 15B are views showing application of a sealer by a sealing nozzle different from the sealing nozzle shown in FIG. 14; and

FIG. 15 is a view showing the shape of the sealer applied as shown in FIG. 14B.

### DETAILED DESCRIPTION OF THE PREFERRED EMBODIMENTS

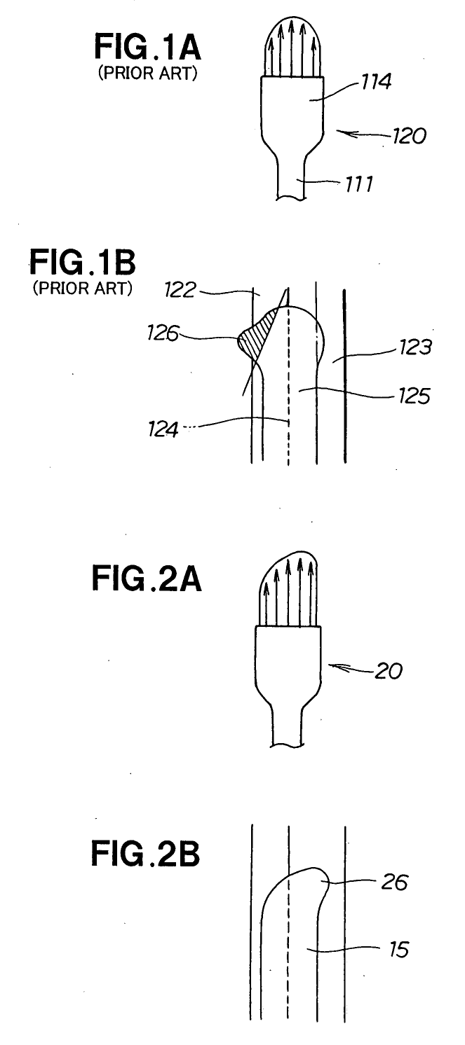

FIGS. 1A through 2B are views that explain details related to the development of the present invention.

A coating shape of a sealer 125 such as the one shown in FIG. 1B is produced using the conventional sealing nozzle 120 shown in FIG. 1A. An inner panel 123 stretches out to the right-hand side in the drawing, and the sealer 125 is therefore allowed to project to the right. By contrast, an overcoated portion 126 that extends outward to the left-hand side in the drawing is not permissible. In other words, the problem is solved by removing the hatched portion.

Using a sealing nozzle 20 that has offset discharge characteristics, such as the one shown in FIG. 2A, may produce a coating that does not have an overcoated portion, as shown in FIG. 2B. Various studies have been conducted into the structure of the sealing nozzle 20 according to the present invention, as described below.

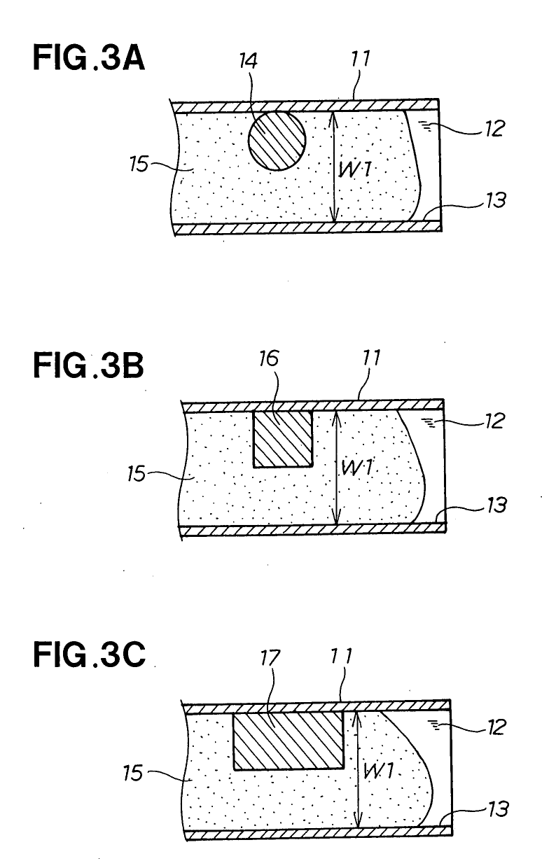

FIGS. 3A through 3C show experimental examples in which a model of a flattened tube part is manufactured by covering a grooved mold material 11 with a transparent sheet 12.

In FIG. 3A, a disk 14 having a diameter of 0.5×W1 was placed into a sealer passage 13 having width W1, and a sealer 15 was caused to flow from the left to the right in the drawing. Due to the resistance of the disk 14, the distal end of the sealer became slightly asymmetrical at this point.

In FIG. 3B, a square plate 16 in which one side measures 0.5×W1 was placed into the sealer passage 13 having width W1, and the sealer 15 was caused to flow from the left to the right in the drawing. Due to the resistance of the square plate 16, the distal end of the sealer became asymmetrical at this point. The degree of asymmetry was more pronounced than that of FIG. 3A.

In FIG. 3C, a rectangular plate 17 in which the short side measures 0.5×W1 and the long side measures W1 was placed into the sealer passage 13 having width W1, and the sealer 15 was caused to flow from the left to the right in the drawing. Due to the resistance of the rectangular plate 17, the distal end of the sealer became asymmetrical at this point. The degree of asymmetry was more pronounced than that of FIG. 3B.

As a result of the above experiments, it was possible to confirm that a sealing nozzle having asymmetrical discharge characteristics could be obtained by placing the disk 14, the square plate 16, or the rectangular plate 17 as a resistance member in the sealer passage 13 at a position that was offset from the center.

Based on the above knowledge, a sealing nozzle that could be used in actual practice was produced on a trial basis.

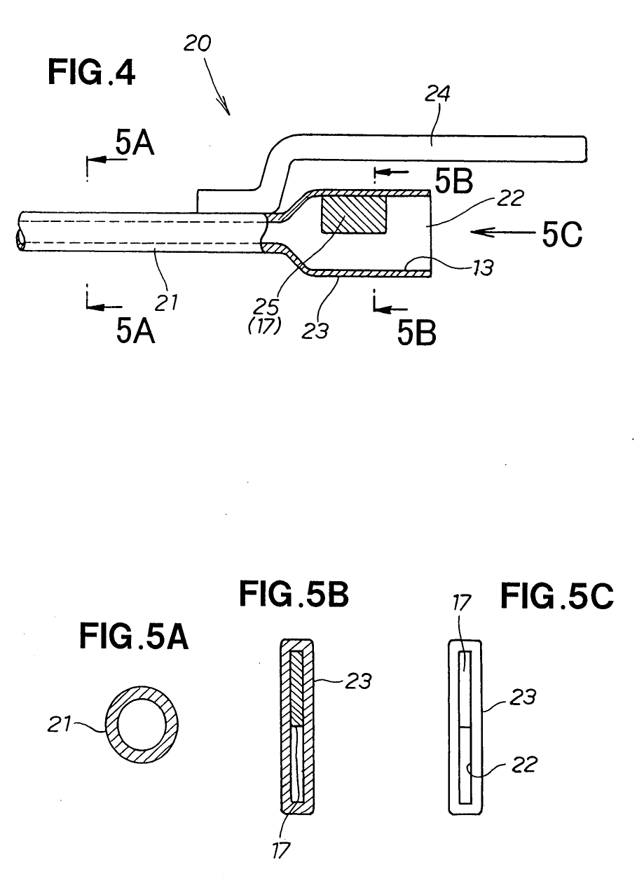

FIG. 4 shows a sealing nozzle according to the present invention.

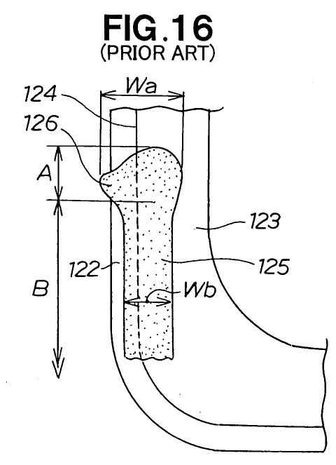

The sealing nozzle 20 comprises a pipe 21 for transporting a sealer, a flattened tubular part 23 provided to the distal end of the pipe 21 and used to discharge the sealer from an oblong opening 22 in the distal end, and a guide member 24 (FIG. 14) that stretches out from the pipe 21 (or the flattened tubular part 23) and is used to guide the flattened tubular part 23 toward an application part of the coating workpiece by following the coating workpiece. A resistance member 25 for restricting the flow of the sealant is provided to the sealer passage 13 of the flattened tubular part 23 at a position close to the guide member 24. A rectangular plate 17 that stretches out along the flow of the sealant is shown as an example of the resistance member 25. In addition, the resistance member 25 can be regarded as a member that projects inward from the exterior of the flattened tubular part 23.

The pipe 21 is a round tube, as shown in FIG. 5A; 50% of the interior of the oblong flattened tubular part 23 is blocked by the rectangular plate 17, as shown in FIG. 5B; and the rectangular plate 17 can be seen through the oblong opening 22, as shown in FIG. 5C.

The operation of the sealing nozzle thus configured will next be described.

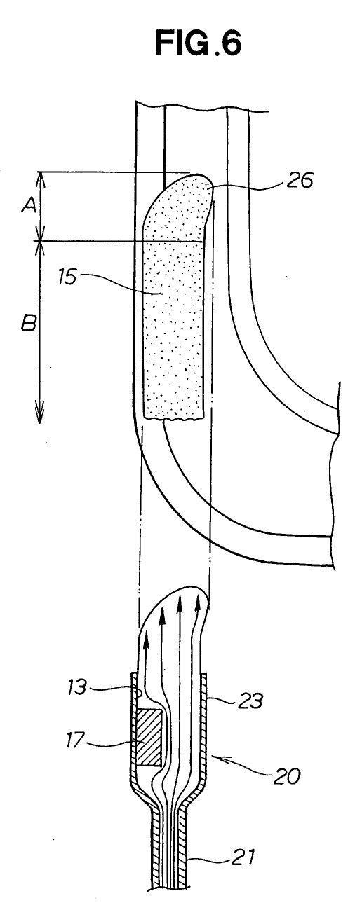

When a sealant is applied using a sealing nozzle 20 such as the one shown in FIG. 6, the application start area A is larger than the application continuation area B, and an overhang 26 appears toward the interior, which is the right-hand side in the drawing. This overhang 26 is allowed. The operation of the rectangular plate 17 disposed inside the sealer passage 13 will now be described.

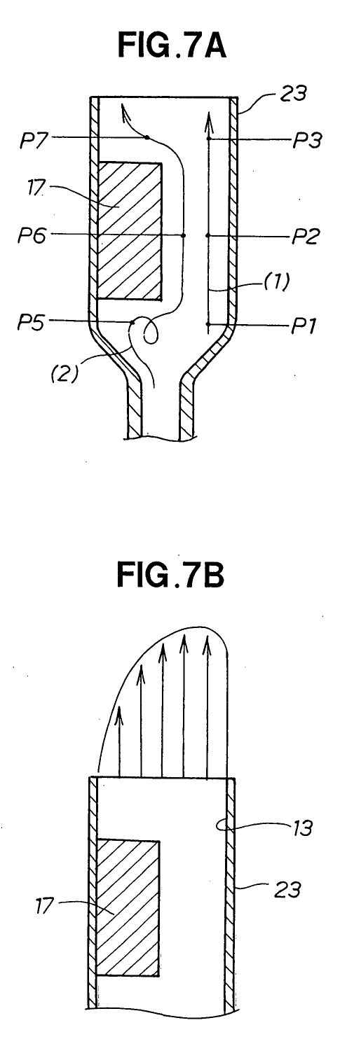

FIGS. 7A and 7B show flowcharts of the interior of the sealing nozzle. The flow inside the nozzle follows the Bernoulli theorem (that the sum of the static pressure and dynamic pressure is constant, assuming that the potential does not change). Static pressure can be expressed as p over density γ (p/γ), and dynamic pressure can be expressed as the square of the flow velocity v over twice the gravitational force g (v²/2 g).

In FIG. 7A, the flow that does not collide with the rectangular plate 17 is shown by arrow (1). Arrow (1) passes from the inlet point P1 of the rectangular plate 17 through the point P2 beside the rectangular plate 17 to the outlet point P3 of the rectangular plate 17. Because the flow passage narrows at point P2, velocity and dynamic pressure increase. Static pressure decreases in proportion to the increase in dynamic pressure, resulting in reduced pressure. In other words, the pressure around point P2 is lower than that around P1.

The flow that collides with the rectangular plate 17 is shown by arrow (2). At point P5, where arrow (2) collides with the rectangular plate 17, velocity temporarily drops to zero. With dynamic pressure reaching zero, the static pressure increases and the pressure rises. The high pressure flow reverses and flows toward point P6 because of the low pressure at P6 (same pressure as at point P2). The velocity then decreases because the flow passage at point P7 suddenly becomes wider.

The flow shown by arrow (2) is accompanied by losses due to collisions, reversions, and changes in direction, and the velocity is lower than that of the flow shown by arrow (1). As a result, an asymmetrically offset discharge flow forms as shown in FIG. 7B.

As is made clear by FIG. 7A, an asymmetrically offset discharge flow can also be obtained by changing the rectangular plate 17 to a square plate or a disk. However, as described with reference to FIG. 2, the rectangular plate 17 is preferred over a square plate or a disk.

If the long side of the rectangular plate 17 is less than twice the length of the short side, e.g., 1.5 times the length, the shape approaches that of a square plate, and a strong offset cannot be obtained. If the long side is more than twice the length of the short side, e.g., three times the length, a strong offset is obtained, but the overall resistance in the flow passage increases, and the cost of powering the sealer application pump increases as well. Therefore, a length-to-width ratio of 2:1 for the rectangular plate 17 is preferred.

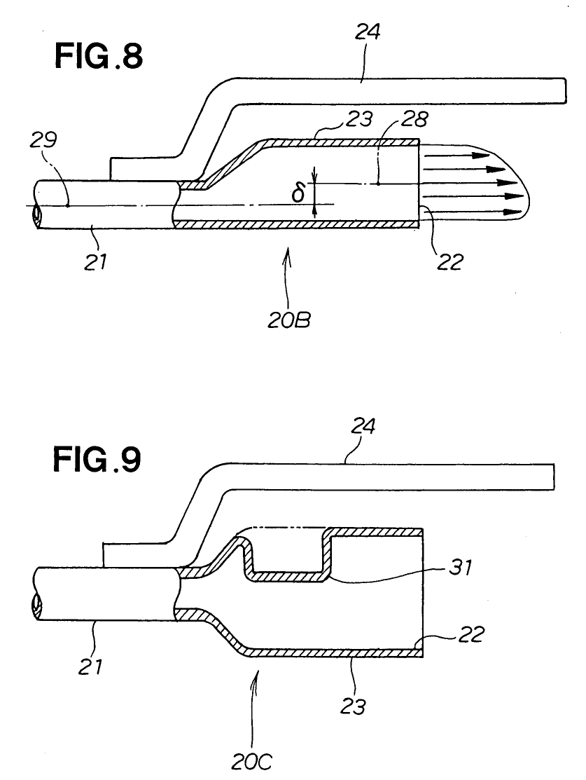

Following is a description of a sealing nozzle of a second embodiment shown in FIG. 8.

The sealing nozzle 20B shown in FIG. 8 comprises a pipe 21 for transporting a sealer, a flattened tubular part 23 provided to the distal end of the pipe 21 and used to discharge the sealer from an oblong opening 22 in the distal end, and a guide member 24 that stretches out from the pipe 21 (or the flattened tubular part 23) and is used to guide the flattened tubular part 23 toward an application part of a coating workpiece by following the coating workpiece. A center line 28 of the flattened tubular part 23 is displaced by 6 from the center line 29 of the pipe 21 toward the guide member 24.

The volume of flow on the side of the guide member 24 can be reduced and an asymmetrical flow can be produced by the displacement δ.

Following is a description of a sealing nozzle of a third embodiment shown in FIG. 9.

The sealing nozzle 20C shown in FIG. 9 comprises a pipe 21 for transporting a sealer, a flattened tubular part 23 provided to the distal end of the pipe 21 and used to discharge the sealer from an oblong opening 22 in the distal end, and a guide member 24 that stretches out from the pipe 21 (or the flattened tubular part 23) and is used to guide the flattened tubular part 23 toward an application part of a coating workpiece by following the coating workpiece. The area (the dotted line portion) of the flattened tubular part 23 near the guide member 24 is sunk in toward the sealer passage 22, forming a salient part 3 1. The salient part 31 can also be regarded as a depression formed so as to be sunk in from the exterior to the interior of the flattened tubular part 23.

When a portion (the salient part 3 1) where such a flow of the sealer is restricted occurs in an area near guide member 24, the sealer that flows out of the oblong opening 22 is truncated on the side near the guiding portion 24. In this way, the overcoated portion can be eliminated and cleanup or other aftertreatment can be omitted in the third embodiment.

In addition, because the flattened tubular part 23 is merely sunk in locally, there is no need to provide separate components, and the cost of material can be kept from rising.

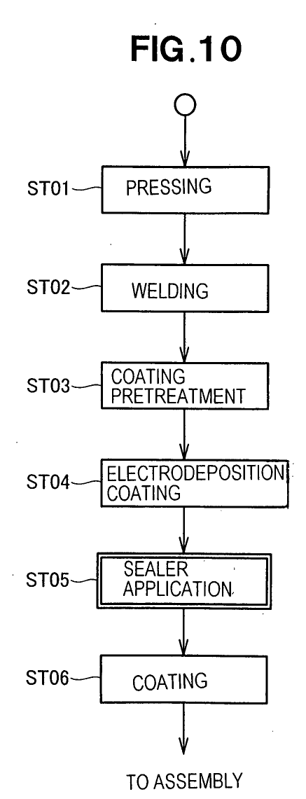

FIG. 10 shows a flowchart that explains the process of manufacturing a vehicle body.

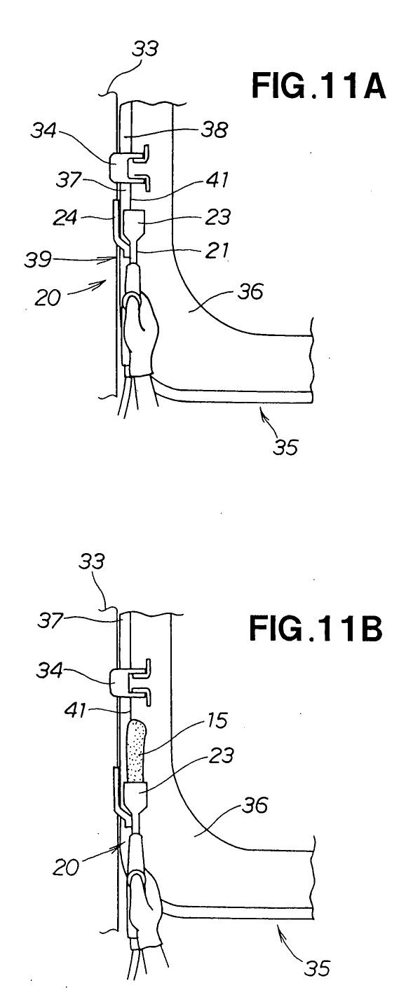

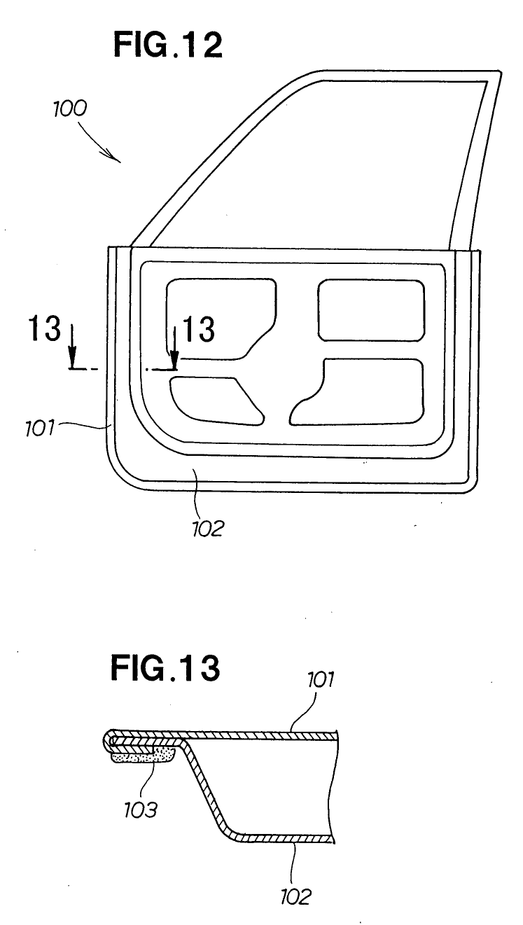

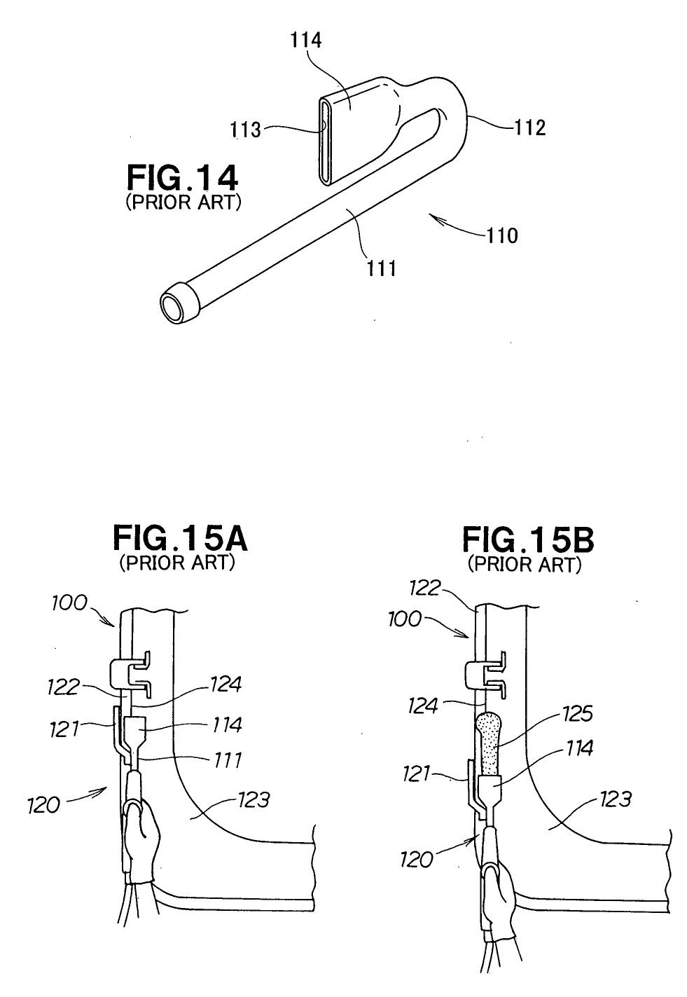

Referring to FIG. 10, the above manufacturing process has a pressing step for pressing a blank (ST01); a welding step for stacking and welding steel sheets that have been pressed together (ST02); a coating pretreatment step for removing weld spatter, oil, and other contaminants to prepare for coating (ST03); and an electrodeposition coating step for forming an undercoating (ST04). A semi-finished part of a vehicle body (for example, a rear door mounted on a center pillar) such as the one shown in FIGS. 11A and 11B is obtained as a result of the above steps. A sealer is applied (ST05) to the work area of the two steel sheets in the semi-finished part of a vehicle body, the main coating is applied in a coating step (ST06), and the part is sent to an assembly line.

FIGS. 11A and 11B show the sealer application step according to the present invention.

The sealing nozzle 20 shown in FIG. 11A comprises a pipe 21 for transporting a sealer, a flattened tubular part 23 provided to the distal end of the pipe 21, and a guide member 24 that stretches out from the pipe 21 or the flattened tubular part 23. The flow of the sealer in the flattened tubular part 23 in proximity to the guide member 24 is slower than the flow in a portion distant from the guide member.

Let us assume that the object of sealer application is a rear door 35 fastened by a door hinge 34 to a center pillar 33. In the rear door 35, an inner plate 36 is superposed with an outer plate 37 as two steel sheets, and the edge part of the outer plate 37 is bent back onto the inner plate 36 to form a unified construction.

A sealer 15 must be applied to an overlapping area 38 of the rear door 35.

At this point, the distal end of the sealing nozzle 20 is lined up with the boundary 41 of an overlapping area 35 while the guide member 24 is made to follow the edge part 39 of the rear door 35 in FIG. 11A.

In FIG. 11B, the sealing nozzle 20 is slowly moved while the sealer 15 is discharged from the sealing nozzle 20, whereupon the boundary line 41 is coated with the sealer 15. The sealer 15 is applied accurately without any overcoating.

Specifically, the sealer 15 is prevented from protruding outside the vehicle body (rear door 35) when the operation to apply the sealer is started. As a result, labor involved in applying the sealer in the manufacturing of a vehicle body can be reduced. Overcoating causes increased water leaks and air cutting noise, as well as formation of rust and crevices. Because such overcoating can be removed in accordance with the present invention, formation of water leaks in the vehicle body can be prevented, the air cutting noise can be reduced, the formation of rust on the vehicle body can be prevented, and the infiltration of dirt into the vehicle body can be prevented as well.

In addition to a vehicle door, the sealing nozzle of the present invention can also be used to apply a sealer to a hood or a vehicle body.

Obviously, various minor changes and modifications of the present invention are possible in light of the above teaching. It is therefore to be understood that within the scope of the appended claims the invention may be practiced otherwise than as specifically described.

1. A sealing nozzle comprising:
a pipe for transporting a sealer;
a flattened tubular part disposed at a distal end of the pipe for discharging a sealer from an oblong opening at a distal end of the flattened tubular part;
a guide member that extends from one of the pipe and the flattened tubular part for guiding the flattened tubular part relative to an application part of a coating workpiece by following the coating workpiece; and
a restriction which reduces flow of the sealer in the flattened tubular part in proximity to the guide member to be slower than flow in an area distant from the guide member.

2. The nozzle according to claim 1, wherein the restriction comprises a resistance member that projects from an internal peripheral surface within an interior of the flattened tubular part, or a depression that is sunk in so as to protrude from an exterior to the interior of the flattened tubular part.

3. The nozzle according to claim 2, wherein the resistance member or the depression has a substantially rectangular configuration.

4. The nozzle according to claim 1, wherein the restriction is arranged within the flattened tubular part such that a center line of the flattened tubular part is displaced toward the guide member and away from a center line of the pipe.

5. A method for producing a body of an automobile by applying a sealer to a work area of at least two steel sheets that constitute the automobile body, the method comprising the steps of:
providing a sealing nozzle having a pipe for transporting a sealer, a flattened tubular part disposed at a distal end of the pipe for discharging the sealer from an oblong opening at a distal end of the flattened tubular part, a guide member that extends from one of the pipe and the flattened tubular part for guiding the flattened tubular part relative to an application part of a coating workpiece by following the coating workpiece, and a restriction which reduces flow of the sealer in the flattened tubular part in proximity to the guide member to be slower than flow in an area distant from the guide member;
bringing the guide member against one edge part of one of the steel sheets; and
applying the sealer to an overlapping area of the steel sheets while sliding the sealing nozzle along the edge part.

6. The nozzle according to claim 1, wherein the resistance member or the depression is disposed in a portion of the flattened tubular part close to the guide member such that the flow of the sealer in the flattened tubular part close to the guide member is slower than the flow in an area distant from the guide member.

7. The nozzle according to claim 1, wherein the disposition of the resistance member in the flattened tubular part modifies the flow of the sealer from the oblong opening of the flattened tubular part at the beginning of a sealer dispensing operation such that any portion of the application part which becomes overcoated with the sealer extends away from the guide member.

8. The method according to claim 5, wherein the restriction comprises a resistance member that projects from an internal peripheral surface within an interior of the flattened tubular part, or a depression that is sunk in so as to protrude from an exterior to the interior of the flattened tubular part.

9. The method according to claim 8, wherein the resistance member or the depression has a substantially rectangular configuration.

10. The method according to claim 5, wherein the restriction is arranged within the flattened tubular part such that a center line of the flattened tubular part is displaced toward the guide member and away from a center line of the pipe.

11. The method according to claim 5, wherein the resistance member or the depression is disposed in a portion of the flattened tubular part close to the guide member such that the flow of the sealer in the flattened tubular part close to the guide member is slower than the flow in an area distant from the guide member.

12. The method according to claim 5, wherein the disposition of the resistance member in the flattened tubular part modifies the flow of the sealer from the oblong opening of the flattened tubular part at the beginning of the applying step such that any portion of the overlapping area of the steel sheets which becomes overcoated with the sealer extends away from the one edge part of one of the steel sheets.
